(19) United States
(12) Patent Application Publication
(10) Pub. No.: US 2003/0103554 A1
(43) Pub. Date: Jun. 5, 2003

(54) Providing a partially encrypted data packet in a spread spectrum signal

(76) Inventors: Yunxin Li, Ryde (AU); Xiaojing Huang, Waverton (AU)

Correspondence Address: MOTOROLA, INC., 1303 EAST ALGONQUIN ROAD, IL01/3RD, SCHAUMBURG, IL, 60196

(21) Appl. No.: 10/011,161

(22) Filed: Dec. 5, 2001

(51) Int. Cl. H04B 1/69

(52) U.S. Cl. 375/141

(57) ABSTRACT

A method, system and electronic device (100) for providing a partially encrypted data packet in a spread spectrum signal. The device has a spread spectrum signal encoder (140) having a data input, an output and a plurality of modulators (202,204,206) with inputs respectively coupled to outputs of a direct sequence generator (110), a scrambling sequence generator (120) and a carrier generator (125). There is also an output unit (150) coupled to an output of the spread spectrum signal encoder (140). In use when a data packet comprising a payload field of bits and non-payload field of bits is received by the spread spectrum signal encoder (140), the modulators (202,204,206) modulate the data packet to provide the partially encrypted data packet with the payload being a spread spectrum signal encrypted by a scrambling sequence from the scrambling sequence generator (120) and the non-payload field comprises a spread spectrum signal free of encryption by said scrambling sequence.

### FIELD OF THE INVENTION

This invention relates to a spread spectrum system and an electronic device, method and system for providing a partially encrypted data packet in a spread spectrum signal. The invention is particularly useful for, but not necessarily limited to, systems and devices with radio frequency communication links.

### BACKGROUND OF THE INVENTION

Spread Spectrum (SS) technologies have been used for anti-jamming and security communications systems as well as commercial cellular and other wireless communications networks. Recently, the demand for low power high speed wireless local area network (WLAN) solutions has been an industry hot topic. Conventional WLAN uses direct sequence spread spectrum (DSSS) signal for transmitting a data packet which normally contains a preamble, a header and a payload and every bit in the packet is spread by a common direct sequence. When receiving a data packet, the receiver despreads the received spread spectrum signal using the same direct sequence and then retrieves the transmitted information from the payload. Unfortunately, by using this conventional DSSS scheme there is unnecessary processing of received data packets that are not meant for all suitable receiving devices. This also has the disadvantage of increase battery consumption as the receiving devices need to process the whole data packet in order to determine if the data packet is meant for the device.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided an electronic device for providing a partially encrypted data packet in a spread spectrum signal, the device comprising:

a spread spectrum signal encoder having a data input, an output and a plurality of modulators;

a direct sequence generator with an output coupled to a modulator of said spread spectrum signal encoder;

a scrambling sequence generator with an output coupled to a modulator of said spread spectrum signal encoder;

a carrier generator with an output coupled to a modulator of said spread spectrum signal encoder; and

an output unit coupled to said output of said spread spectrum signal encoder,

wherein in use when a data packet comprising a payload field of bits and non-payload field of bits is received at said data input of said spread spectrum signal encoder, said modulators of said spread spectrum signal encoder modulate said data packet to provide said partially encrypted data packet with said payload being a spread spectrum signal encrypted by a scrambling sequence from said scrambling sequence generator and at least part of said non-payload field comprises a spread spectrum signal free of encryption by said scrambling sequence.

The electronic device may also include an input unit coupled to a spread spectrum signal decoder, wherein in use the spectrum signal decoder decodes received partially encrypted data packets comprising a payload field of bits that is a spread spectrum signal encrypted by a scrambling sequence and at least part of said non-payload field of bits comprising a spread spectrum signal free of encryption by said scrambling sequence.

Suitably, in use the spread spectrum signal decoder may decode said payload field of bits to provide a decoded bit stream.

Suitably, the spread spectrum signal decoder may have inputs coupled to outputs of said direct sequence generator, said direct sequence generator and said carrier generator.

The spread spectrum signal decoder may suitably include an IQ demodulator with an input coupled to an output of said carrier generator.

The spread spectrum signal decoder may suitably include multipliers with respective inputs coupled to outputs of said direct sequence generator, said direct sequence generator.

Suitably, the output unit may include a radio transmitter.

The output unit may include a modem. Preferably, the output unit may provide for connection and transmission of the spread spectrum signal to a wired communication link.

The electronic device may be a radio communication device such as a two-way radio communication device. There may be digital signal providing circuitry with an output coupled to said data input and in input of said digital signal providing circuitry may be coupled to an user interface. Typically, the signal providing circuitry may preferably includes a digital data store. The digital signal providing circuitry may suitably convert signals from said user interface into a said data packet.

According to another aspect of the invention there is provided a method for providing a partially encrypted data packet in a spread spectrum signal, the method comprising the steps of:

receiving a data packet comprising a payload field of bits and non-payload field of bits;

modulating said data packet to provide said partially encrypted data packet with said payload field of bits being a spread spectrum signal encrypted by a scrambling sequence and at least part of said non-payload field comprises a spread spectrum signal free of encryption by said scrambling sequence; and

transmitting said partially encrypted data packet.

Suitably, method may further include the steps of:

receiving a received partially encrypted data packet with a received payload field of bits being a spread spectrum signal encrypted by a scrambling sequence and at least part of a received non-payload field of bits comprising a spread spectrum signal free of encryption by said scrambling sequence;

decoding said transmitted payload field of bits; and

providing, after said decoding, a decoded bit stream from said received payload field of bits.

According to another aspect of the invention there is provided a spectrum signal communication system comprising: a communication link; and a plurality of electronic devices for providing a partially encrypted data packet in a spread spectrum signal, the electronic devices being in communication with each other by the communication link, and the electronic devices comprising:

a spread spectrum signal encoder having a data input, an output and a plurality of modulators;

a direct sequence generator with an output coupled to a modulator of said spread spectrum signal encoder;

a scrambling sequence generator with an output coupled to a modulator of said spread spectrum signal encoder;

a carrier generator with an output coupled to a modulator of said spread spectrum signal encoder; and

an output unit coupled to said output of said spread spectrum signal encoder,

wherein in use when a data packet comprising a payload field of bits and non-payload field of bits is received at said data input of said spread spectrum signal encoder, said modulators of said spread spectrum signal encoder modulate said data packet to provide said partially encrypted data packet with said payload being a spread spectrum signal encrypted by a scrambling sequence from said scrambling sequence generator and at least part of said non-payload field comprises a spread spectrum signal free of encryption by said scrambling sequence.

The electronic device of the spread spectrum signal communication system may suitably include any or all of the above elements or functions.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic block diagram of an electronic device for providing a spread spectrum signal in accordance with the invention;

FIG. 2 is a schematic block diagram of a spread spectrum signal encoder comprising part of the electronic device of FIG. 1;

FIG. 3 is a schematic block diagram of a spread spectrum signal decoder comprising part of the electronic device of FIG. 1;

FIG. 4 is a diagram of a format of a data packet FIG. 5 is a flow diagram illustrating a method for providing a partially encrypted data packet in a spread spectrum signal; and

FIG. 6 is a schematic block diagram of a spread spectrum signal communications system.

### DETAILED DESCRIPTION OF A PREFERRED EMBODIMENT OF THE INVENTION

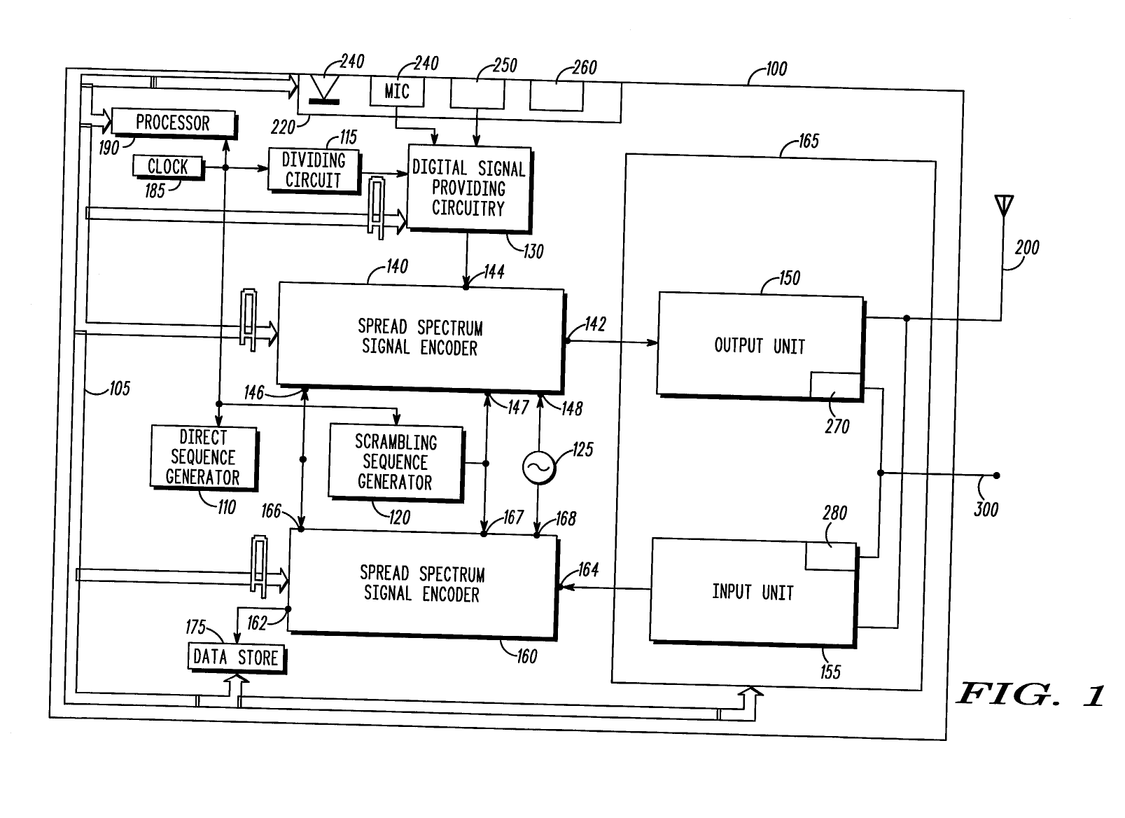

Referring to FIG. 1 there is illustrated a schematic block diagram of an electronic device 100 for providing a partially encrypted data packet in a spread spectrum signal. The electronic device 100 is typically a single or two way radio communication device, it may also form part of a computer or other processing unit coupled to a network by a wired communication link or radio link. The electronic device 100 includes a spread spectrum signal encoder 140 and a digital signal providing circuitry 130 coupled to a data input 144 of spread spectrum signal encoder 140. There is also an output unit 150 coupled to an output 142 of spread spectrum signal encoder 140.

The electronic device 100 also includes a spread spectrum signal decoder 160 with an input 164 coupled to an input unit 155 by a buffer (not illustrated) that forms part of input unit 155. An output 162 of the spread spectrum signal decoder 160 is coupled to a digital data store 175.

In order to provide a partially encrypted spread spectrum signal, the electronic device 100 includes a clock 185 coupled to a processor 190 (with associated memory not shown), an input of a direct sequence generator 110 and an input of a scrambling sequence generator 120. The clock 185 is also coupled, through a dividing circuit 115, to the digital signal providing circuitry 130. An output of the direct sequence generator 110 is coupled to both an input 146 of the spread spectrum signal encoder 140 and an input 166 of the spread spectrum signal decoder 160. Further, an output of the scrambling sequence generator 120 coupled to both an input 147 of the spread spectrum signal encoder 140 and an input 167 of the spread spectrum signal decoder 160. There is also a carrier generator 125 with outputs coupled to both an input 148 of the spread spectrum signal encoder 140 and an input 168 of the spread spectrum signal decoder 160.

The output unit 150 includes a radio transmitter coupled to a common antenna 200. The input unit 155 includes a radio receiver coupled to the common antenna 200. The output unit 150 and input unit 155 form part of a communication port 165. Further, a transmitter modem 270 forms part of output unit 150 and a receiver modem 280 forms part of input unit 155. Alternatively, output unit 150 and input unit 155 may be compatible for direct network connection (by a wired communication link or otherwise), and provide an Ethernet port at a port node 300 of the communications port 165.

There is also a user interface 220 having, in one embodiment, a microphone 230, a speaker 240, an input command or data device, typically in the form of a interactive display screen or keypad 250, and an optional display screen 260. The microphone 230 and keypad 250 are coupled to the digital providing circuitry 130. A combined data and address bus 105 couples the processor 190 to the user interface 220, the spread spectrum signal encoder 140, the spread spectrum signal decoder 160, the digital signal providing circuitry 130, the data store 175, the digital signal providing circuitry 130 and the communication port 165.

As will be apparent to a person skilled in the art, the digital signal providing circuitry 130 is a memory buffer for storing digitised speech, text or data. Similarly, the data store 175 is a memory for storing received data or information received by the input unit 155 and decoded by decoder 160. The stored received data or information is subsequently accessed by the processor 190 or it may be sent to the speaker 240 (after processing) or display screen 260.

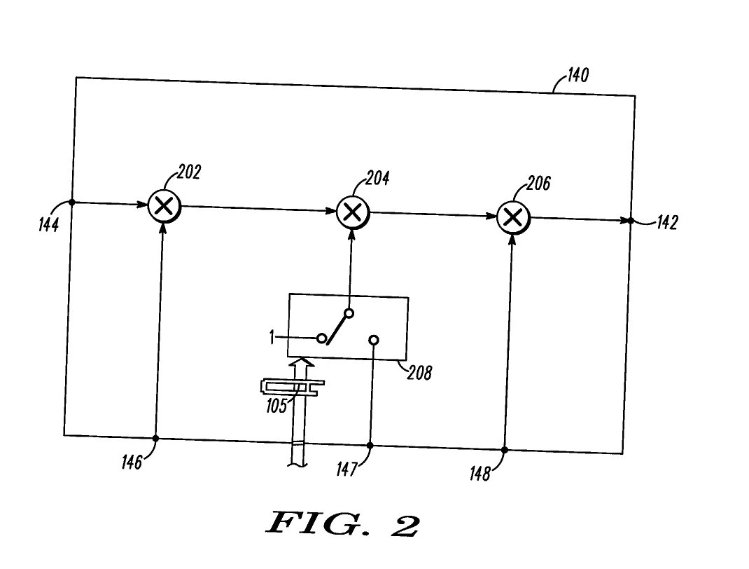

Referring to FIG. 2 there is illustrated a schematic block diagram of the spread spectrum signal encoder 140 comprising a direct sequence spreading modulator 202 with one input being the data input 144 and a modulation input being from the input 146 that is coupled to the direct sequence generator 110. An output of the direct sequence spreading modulator 202 is coupled to a data input of an encryption modulator 204. The encryption modulator 204 has an encryption modulation input coupled to an output of a switching unit 208 and an output of the encryption demodulator 204 is coupled to an encrypted data input of a carrier frequency modulator 206 that has a carrier frequency input provided by input 148 that is coupled to the carrier generator 125. An output of the carrier frequency modulator 206 is provided by the output 142. The switching unit 208 has two inputs one being coupled to a constant value of logic 1 (for instance a 5 Volt line) and the other being the input 147 that is coupled to the scrambling sequence generator 120. The bus 105 is also coupled to the switching unit 208 to control switching thereof.

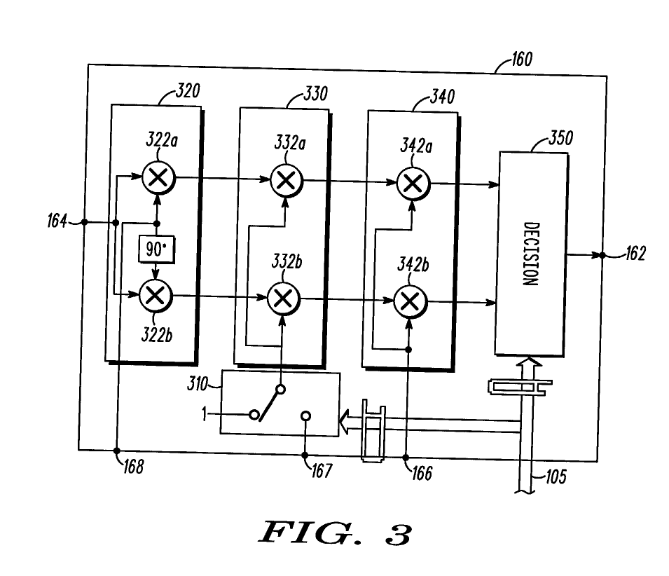

Referring to FIG. 3 there is illustrated a schematic block diagram of the a spread spectrum signal decoder 160 comprising a carrier frequency IQ demodulator unit 320 with an in phase demodulator 322a and a quadrature demodulator 322b each having a received data input provided by input 164 that is coupled to the input unit 155. The in phase demodulator 322a has a carrier frequency demodulation input provided by input 168 that is coupled to the carrier generator 125. The quadrature demodulator 322b has a carrier frequency demodulation input coupled through a 90 degree phase shift circuit 323 to input 168. The phase shift circuit 323 provides an out of phase demodulation carrier frequency to the quadrature demodulator 322b relative to the carrier frequency associated with the in phase demodulator 322a supplied directly from input 168.

The spread spectrum signal decoder 160 also has a decryption unit 330 with multipliers 332a and 332b coupled to respective outputs of the in phase and quadrature multipliers 322a,322b. Each of the multipliers 332a and 332b has an input coupled to an output of a switching unit 310. The switching unit 310 has two inputs one being coupled to a constant value of logic 1 (a 5 Volt line) and the other being the input 167 that is coupled to the scrambling sequence generator 120. The bus 105 is also coupled to the switching unit 310 to control the switching thereof.

There is also a despreading unit 340 with multipliers 342a and 342b coupled to respective outputs of the multipliers 332a and 332b. Each of the multipliers 342a and 342b has an input provided by input 166 that is coupled to the direct sequence generator 110. Outputs of multipliers 342a and 342b are coupled to a decision unit 350 that has an output provided by output 162 that is coupled to the data store 175. The bus 105 is also coupled to the decision unit 350 for communication with the processor 190.

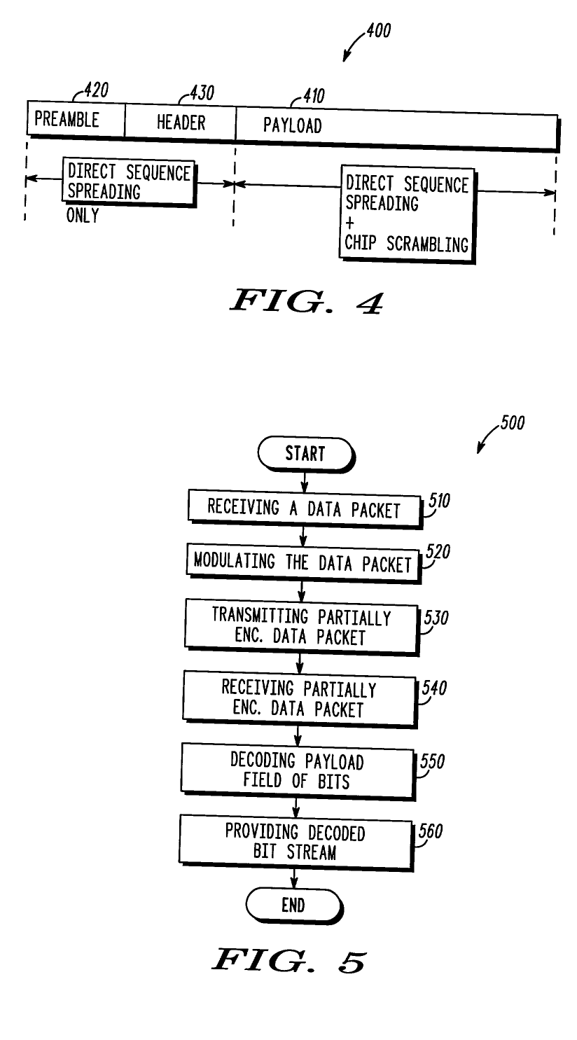

Referring to FIG. 4 there is illustrated a diagram of a data packet 400. The data packet 400 includes a payload field of bits 410 and a non-payload field of bits comprising a preamble field 420 and header field 430. The payload field of bits 410 is basically data such as digitized speech or text (symbols) and the preamble field 420 has a standard protocol bit sequence used for synchronization purposes and the header field 430 includes information regarding length of the payload field of bits 410, modulation type and scrambling enable and scrambling sequence settings.

Referring to FIG. 5 there is illustrated a method 500 for providing a partially encrypted data packet in a spread spectrum signal. The method 500 is effected by the electronic device 100 and at a receiving a data packet step 510, the data packet 400 is sent from the digital signal providing circuitry 130 to the spread spectrum signal encoder 140.

At a modulating step 520, the spread spectrum signal encoder 140 then modulates the data packet 400 to provide a partially encrypted data packet with the payload field of bits 410 being a spread spectrum signal encrypted by a chip scrambling sequence and the preamble and header fields 420,430 (the non-payload field) comprises a spread spectrum signal free of encryption by the scrambling sequence. At the modulating step, the direct sequence generator 110 provides a direct sequence of bits D[j] (j being an index for the No. of bits) to the modulation input of the direct sequence spreading modulator 202. The direct sequence of bits D[j] is generated by the direct sequence generator 110 in a conventional manner as will be apparent to a person skilled in the art.

At the output of the direct sequence spreading modulator 202, all the bits of the data packet 400 have been direct sequence spread to form a spread spectrum signal in which each of the bits has been spread into an sequence of chips. The chips are then modulated by the encryption modulator 204 whereby the processor controls the switching unit 208 to firstly modulate the sequence of chips in the preamble and header fields 420,430 by the constant value of logic 1 and thereafter the switching unit 208 switches to supply a scrambling/encryption sequence S[j] from the scrambling sequence generator 120 to modulate payload field of bits that were converted into chips by modulator 202. The output of encryption modulator 204 is frequency modulated by the carrier frequency modulator 206, the carrier frequency being provided to the carrier frequency modulator 206 by the carrier generator 125.

At a transmitting step 530, the output 142 supplies the frequency modulated partially encrypted data packet, to the output unit 150, in which a direct sequence of bits D[j] has been applied to all bits of the data packet 400. All bits are thereby direct sequence spread to form a spread spectrum signal in which all of the bits have been spread into an sequence of chips. The payload field of bits 410 has also been spread spectrum signal encrypted by the chip scrambling sequence S[j] whereas the non-payload field comprises a spread spectrum signal free of encryption by the chip scrambling sequence S[j]. The partially encrypted data packet is transmitted by the output unit in a spread spectrum signal.

At a receiving step 540, the electronic device 100 may receive, at the input unit 155, a received partially encrypted data packet in a spread spectrum signal transmitted from another similar device. As will be apparent to a person skilled in the art, received spread spectrum signals may be asynchronous and therefore synchronization techniques are used to demodulate the spread spectrum signal. One of the synchronization techniques is for the decision unit 350 to correlate the preamble sub-field of a data packet with the received spread spectrum signal. Upon synchronization, the decision unit 350 sends synchronization data to the processor 190. Thus the received signal is synchronized at the epoch when the maximum correlation is reached. After signal synchronization, the header sub-field of a data packet is first decoded by the spread spectrum signal decoder 160. As this sub-field is not chip scrambled, the switching unit 310 is connected to the constant value of logic 1. The baseband spread spectrum signal of the header at the output of the IQ carrier frequency demodulator unit 320 is passed through the decryption unit 330 and despread by the despreading unit 340. After the decision unit 350 determines the information contained in the header regarding the length, modulation type, scrambling enable and scrambling sequence settings of the payload field of bits 410, it acknowledges the processor 190 via the bus 105 and the processor will switch the switching unit 310 to the input coupled to the input 167 of the decoder 160 that is connected to the scrambling sequence generator 120 at the end of the header sub-field.

At a decoding step 550 the partially encrypted data packet is decoded by the spread spectrum decoder 160 to provide a decoded field of bits 410. The decoding step 550 firstly demodulates the similar partially encrypted data packet with the carrier frequency from the carrier generator 125 being applied to the IQ carrier frequency demodulator unit 320. A payload bit field 410 of the baseband signal at the output of the IQ carrier frequency demodulator unit 320 is then decrypted by the decryption unit 330 with the de-scrambling sequence supplied by the scrambling sequence generator 120. In this regard the switching unit 310 firstly provides, during processing of the non-payload fields 420,430, a constant logic 1 value to the inputs of the multipliers of the decryption unit 330 and thereafter the descrambling sequence supplied is to the payload field of bits 410. The despreading unit 340 then dispreads the output spread spectrum signal from decryption unit 330, with a despreading sequence from the direct sequence generator 110, The decision unit then determines the most likely symbol(s) from the received payload field of bits to provide to the data store 175, at a providing step 560, a decoded bit stream for subsequent sending to user interface 220 or processing by processor 190.

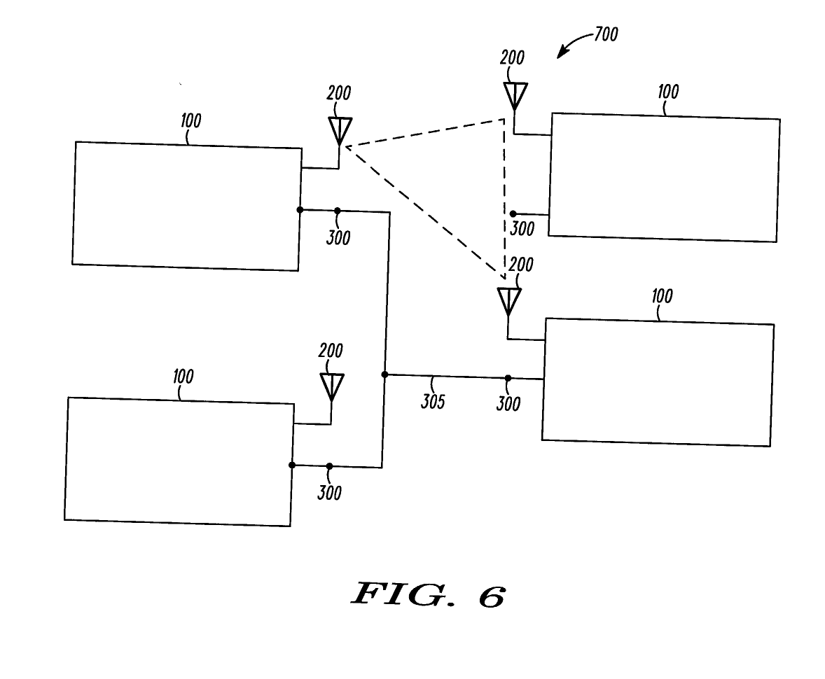

In FIG. 6. there is illustrated a schematic block diagram of a spread spectrum signal communication system 700 comprising a plurality of electronic devices 100 communicating with each other either by port nodes 300 coupled by wired communication links 305 or by antennas 200 using radio waves.

Advantageously, the present invention provides for selectively partially encrypting data packets so that non-payload filed remain unencrypted. Accordingly, any suitable device can determine the type of message from the unencrypted preamble and header fields 420,430 but only pre-selected individual device or federations of devices can decode the payload. This therefore provides for unnecessary processing (attempted decrypting) of received data packets that were not meant for the device 100. This advantageously saves battery consumption, as once a device determines a received signal of data packets is not meant for the device, it can operate in sleep mode until another signal is received.

Other advantages of the present invention include potentially improving robustness against interference and improved security levels. When the invention is used in a DSSS communications system, interference due to signal collision with other mobile stations (or users) can be reduced. Since the chip scrambling sequence can be unique for each user of federation of users, only the intended destination user or federation of users can receive and decode the signal, whereas the signal sent to other user is ignored because the cross-correlation between different scrambling sequences is ideally zero. As a result, the network throughput can be increased. By the use of chip scrambling, the network security may be enhanced because an unauthorized user has no knowledge of which chip scrambling sequence is used so that it is impossible for it to detect the information message encoded in the scrambled signal.

Although the invention has been described with reference to a preferred embodiment it is to be understood that the invention is not restricted to the particular embodiment described herein. For example, the spread spectrum encoder 140 and spread spectrum signal decoder 160 can be implemented in software.

We claim:

1. An electronic device for providing a partially encrypted data packet in a spread spectrum signal, the device comprising:
a spread spectrum signal encoder having a data input, an output and a plurality of modulators;
a direct sequence generator with an output coupled to a modulator of said spread spectrum signal encoder;
a scrambling sequence generator with an output coupled to a modulator of said spread spectrum signal encoder;
a carrier generator with an output coupled to a modulator of said spread spectrum signal encoder; and
an output unit coupled to said output of said spread spectrum signal encoder,
wherein in use when a data packet comprising a payload field of bits and non-payload field of bits is received at said data input of said spread spectrum signal encoder, said modulators of said spread spectrum signal encoder modulate said data packet to provide said partially encrypted data packet with said payload being a spread spectrum signal encrypted by a scrambling sequence from said scrambling sequence generator and at least part of said non-payload field comprises a spread spectrum signal free of encryption by said scrambling sequence.

2. An electronic device as claimed in claim 1, said electronic device further including an input unit coupled to a spread spectrum signal decoder,
wherein in use the spectrum signal decoder decodes received partially encrypted data packets comprising a payload field of bits that is a spread spectrum signal encrypted by a scrambling sequence and at least part of said non-payload field of bits comprising a spread spectrum signal free of encryption by said scrambling sequence.

3. An electronic device as claimed in claim 2, wherein in use the spread spectrum signal decoder decodes said payload field of bits to provide a decoded bit stream.

4. An electronic device as claimed in claim 3, wherein the spread spectrum signal decoder has inputs coupled to outputs of said direct sequence generator, said direct sequence generator and said carrier generator.

5. An electronic device as claimed in claim 3, wherein the spread spectrum signal decoder includes an IQ demodulator with an input coupled to an output of said carrier generator.

6. An electronic device as claimed in claim 3, wherein the spread spectrum signal decoder has multipliers with respective inputs coupled to outputs of said direct sequence generator, said direct sequence generator.

7. An electronic device as claimed in claim 1, wherein said electronic device is a radio communication device.

8. A method for providing a partially encrypted data packet in a spread spectrum signal, the method comprising the steps of:
receiving a data packet comprising a payload field of bits and non-payload field of bits;
modulating said data packet to provide said partially encrypted data packet with said payload field of bits being a spread spectrum signal encrypted by a scrambling sequence and at least part of said non-payload field comprises a spread spectrum signal free of encryption by said scrambling sequence; and
transmitting said partially encrypted data packet.

9. A method as claimed in claim 8, wherein the method method further includes the steps of:
receiving a received partially encrypted data packet with a received payload field of bits being a spread spectrum signal encrypted by a scrambling sequence and at least part of a received non-payload field of bits comprising a spread spectrum signal free of encryption by said scrambling sequence;
decoding said transmitted payload field of bits; and
providing, after said decoding, a decoded bit stream from said received payload field of bits.

10. A spectrum signal communication system comprising: a communication link; and a plurality of electronic devices for providing a partially encrypted data packet in a spread spectrum signal, the electronic devices being in communication with each other by the communication link, and the electronic devices comprising:
a spread spectrum signal encoder having a data input, an output and a plurality of modulators;
a direct sequence generator with an output coupled to a modulator of said spread spectrum signal encoder;
a scrambling sequence generator with an output coupled to a modulator of said spread spectrum signal encoder;
a carrier generator with an output coupled to a modulator of said spread spectrum signal encoder; and
an output unit coupled to said output of said spread spectrum signal encoder,
wherein in use when a data packet comprising a payload field of bits and non-payload field of bits is received at said data input of said spread spectrum signal encoder, said modulators of said spread spectrum signal encoder modulate said data packet to provide said partially encrypted data packet with said payload being a spread spectrum signal encrypted by a scrambling sequence from said scrambling sequence generator and at least part of said non-payload field comprises a spread spectrum signal free of encryption by said scrambling sequence.

11. A spectrum signal communication system as claimed in claim 10, wherein said electronic device includes an input unit coupled to a spread spectrum signal decoder,
wherein in use the spectrum signal decoder decodes received partially encrypted data packets comprising a payload field of bits that is a spread spectrum signal encrypted by a scrambling sequence and at least part of said non-payload field of bits comprising a spread spectrum signal free of encryption by said scrambling sequence.

12. A spectrum signal communication system as claimed in claim 11, wherein in use the spread spectrum signal decoder decodes said payload field of bits to provide a decoded bit stream.

13. A spectrum signal communication system as claimed in claim 12, wherein the spread spectrum signal decoder has inputs coupled to outputs of said direct sequence generator, said direct sequence generator and said carrier generator.

14. A spectrum signal communication system as claimed in claim 12, wherein the spread spectrum signal decoder includes an IQ demodulator with an input coupled to an output of said carrier generator.

15. A spectrum signal communication system as claimed in claim 12, wherein the spread spectrum signal decoder has multipliers with respective inputs coupled to outputs of said direct sequence generator, said direct sequence generator.

16. A spectrum signal communication system as claimed in claim 11, wherein said electronic device is a radio communication device.
